(19) United States
(12) Patent Application Publication
(10) Pub. No.: US 2024/0289632 A1
(43) Pub. Date: Aug. 29, 2024

(54) ALIGNING LARGE LANGUAGE MODELS WITH SPECIFIC OBJECTIVES USING REINFORCEMENT LEARNING AND HUMAN PREFERENCE

(71) Applicant: Maplebear Inc., San Francisco, CA (US)

(72) Inventors: Li Tan, Fremont, CA (US); Haixun Wang, Bellevue, WA (US); Jian Li, Santa Clara, CA (US)

(21) Appl. No.: 18/588,622

(22) Filed: Feb. 27, 2024

Related U.S. Application Data
(60) Provisional application No. 63/487,207, filed on Feb. 27, 2023.

(51) Int. Cl. G06N 3/092; H04L 51/02

(52) U.S. Cl. CPC G06N 3/092; H04L 51/02

(57) ABSTRACT

An online system trains a specific-purpose LLM. The online system obtains training examples and divides training examples across batches. The online system generates a specific response by applying parameters of the specific-purpose LLM to a batch of training examples. The online system generates a general response by applying parameters of a general-purpose LLM to the batch of training examples. The online system computes a human readability score representing the difference between the specific response and the general response. The online system computes an objective compliance score by applying an evaluation model to the specific response, the evaluation model trained to score the first response based on a specific objective. The online system updates the parameters of the specific-purpose LLM based on the human readability score and the objective compliance score.

### CROSS REFERENCE TO RELATED APPLICATIONS

This application claims the benefit of U.S. Provisional Application No. 63/487,207, filed Feb. 27, 2023, which is incorporated by reference in its entirety.

### BACKGROUND

Language Models (LM) are generally referred to as machine learning models that can understand and generate text. Large Language Models (LLM) are large models that include billions or hundreds of billions of parameters, sometimes at the petabyte scale. Due to the large datasets, LLMs often perform well in zero-shot or few-shot scenarios where little domain training data is available. LLMs are trained such that their responses satisfy general objectives, such as usefulness, truthfulness, and harmlessness. While this training process allows LLMs to produce high-quality responses for general purposes, when applied to specific-purposes, LLMs tend to produce responses that are low in quality and irrelevant to the specific purpose.

### SUMMARY

In accordance with one or more aspects of the disclosure, an online concierge system trains a specific-purpose LLM using a general-purpose LLM and an evaluation model. In the training process, the online concierge system evaluates the response of the specific-purpose LLM with two scores: a human readability score representing how well the response meets general objectives and an objective compliance score representing how well the response meets specific objectives. The online concierge system computes the human readability score by comparing the response generated by the specific-purpose LLM to a response generated by a general-purpose LLM. The online concierge system computes the objective compliance score by applying an evaluation model to the response generated by the specific-purpose LLM.

In one or more embodiments, an online system obtains a set of training examples and divides the set of training examples across one or more batches for one or more iterations of training parameters of the specific-purpose LLM. For one or more iterations, the online concierge system trains the specific-purpose LLM. The online system generates a specific response by applying a set of parameters of the specific-purpose LLM to a batch of training examples. The online system generates a general response by applying a set of parameters of a general-purpose LLM to the batch of training examples. The online system computes a human readability score representing the difference between the specific response and the general response. The online system computes an objective compliance score by applying an evaluation model to the specific response, the evaluation model trained to score the first response based on a specific objective. The online system updates the parameters of the specific-purpose LLM based on the human readability score and the objective compliance score.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 is a flowchart for a method of training a specific-purpose LLM, in accordance with one or more embodiments.

FIG. 4 is a block diagram illustrating training of a specific-purpose LLM, in accordance with one or more embodiments.

### DETAILED DESCRIPTION

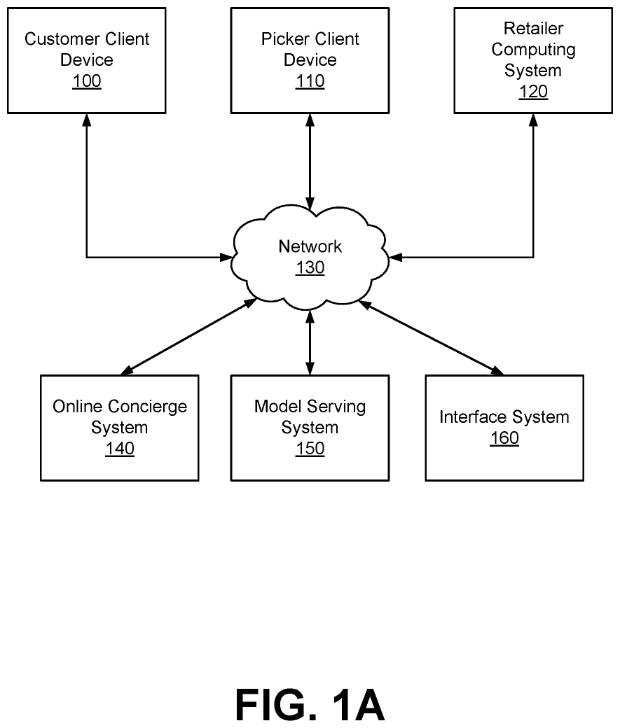

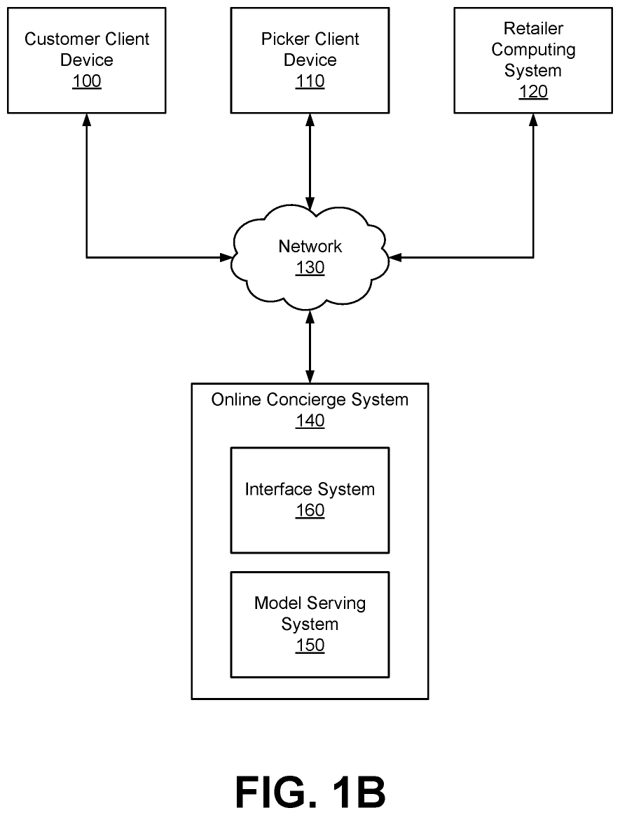

FIG. 1A illustrates an example system environment for an online concierge system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generally referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

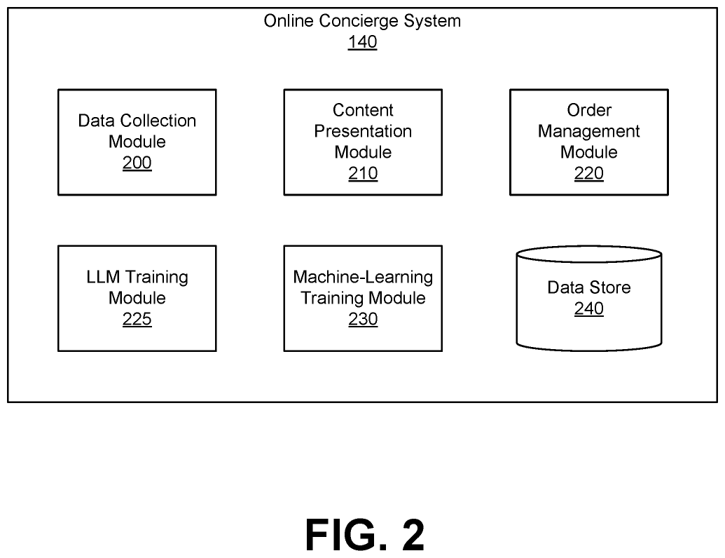

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online concierge system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The LLM training module 225 trains a specific-purpose LLM using a general-purpose LLM and an evaluation model. A general-purpose LLM is an LLM trained for a broad range of purposes or applications. For example, a general-purpose LLM may be usable as a general-purpose online chatbot, to which a user can ask a question related to any topic and expect the chatbot to output a result. The general-purpose LLM may be trained such that its responses meet general objectives. General objectives may refer to objectives relating to the quality of the general-purpose LLM's response, such as how useful the response is, how truthful the response is, and how harmless the response is. A specific-purpose LLM is an LLM trained for a specific purpose or trained to meet specific objectives. An example specific-purpose LLM may be an LLM used by a movie recommendation system, where a user may ask questions related to movies (e.g., “What's a good movie to watch on a rainy fall day in NYC?”) and expect a response in return (e.g., “The movie ‘When Harry Met Sally’ might be a good match for you. It's a romantic comedy set in New York City during the Fall”). Specific objectives may be objectives related to the specific application. To use the same example, a specific objective for a movie recommendation LLM may be how likely the user is to watch the recommended movie. For example, if trained with the specific objective, the movie recommendation LLM may learn that the user is unlikely to watch romantic comedies, and instead suggest a different movie. An evaluation model is a machine learning model trained to score a response of the specific-purpose LLM based on the specific objectives. For example, for a user that does not enjoy romantic comedy movies with the objective being the likelihood that the user will watch the movie, the evaluation model may rate a response that recommends a romantic comedy movie (e.g., “The movie ‘When Harry Met Sally’ might be a good match for you . . . ”) lower than a response that recommends a thriller movie (e.g., “You should watch ‘Uncut Gems.’”). The evaluation model may be trained based on user data or item data. In some embodiments, the LLM training module 225 trains the specific-purpose LLM based on the general-purpose LLM and the evaluation model by applying the reinforcement learning from human feedback algorithm.

In one or more embodiments, the LLM training module 225 may supplement the general-purpose LLM with additional data related to the specific application or specific objectives associated with the specific-purpose LLM. For example, for a movie recommendation LLM, the LLM training module 225 may supplement or “fine-tune” the general-purpose LLM with a catalog of items available to a user.

To train the specific-purpose LLM, the LLM training module 225 obtains a set of training examples. The training examples may be prompts for the specific-purpose LLM. For example, a training example may be “What's a good movie to watch on a rainy fall day in NYC?” In one or more embodiments, the training examples may be unlabeled, that is, not paired with an expected response from the specific-purpose LLM. The LLM training module 225 divides the set of training examples across one or more batches for one or more iterations of training parameters of the specific-purpose LLM. For example, the LLM training module 225 may divide the training examples into one million batches and train the specific-purpose LLM over one million training iterations.

The LLM training module 225 trains the specific-purpose LLM by iterating between a forward pass step and a backpropagation step. In the forward pass step, the LLM training module 225 passes the batch of training examples through the specific-purpose LLM, applying the parameters of the specific-purpose LLM to the batch of training examples. The LLM training module 225 receives a response from the specific-purpose LLM, herein referred to as the “specific response.”

The LLM training module 225 evaluates the specific response. In one or more embodiments, the LLM training module 225 evaluates the specific response by computing two scores: a human readability score and an objective compliance score. The human readability score represents how well the specific response meets general objectives, such as how readable the response is, useful the response is, how truthful the response is, or how harmless the response is. The objective compliance score represents how well the specific response meets the specific-objectives.

The LLM training module 225 computes the human readability score of the specific response by comparing the specific response generated by the specific-purpose LLM to a general response generated by a general-purpose LLM. The general-purpose LLM may be a pre-trained LLM, trained such that its responses meet general objectives. In one or more embodiments, the general-purpose LLM may be an open source LLM. The LLM training module 225 applies parameters of the general-purpose LLM to the batch of training examples, producing a response. The response output from the general-purpose LLM may be referred to herein as the “general response.” The LLM training module 225 computes the human readability score based on comparison of (or difference between) the specific response and the general response. In one or more embodiments, the LLM training module 225 computes the human readability score as the Kullback-Leibler (KL) divergence between the specific response and the general response.

The LLM training module 225 computes the objective compliance score of the specific response by applying the evaluation model to the specific response. As previously described, the evaluation model is a machine learning model trained to score the specific response based on specific objectives. The evaluation model receives the specific response as input and outputs a corresponding objective compliance score.

In the backpropagation step, the LLM training module 225 updates the parameters of the specific-purpose LLM. The LLM training module 225 updates the parameters of the specific-purpose LLM based on the human readability score and the objective compliance score. The LLM training module 225 may combine the human readability score and the objective compliance score into a combined score for the specific response (e.g., by computing a linear combination of the two scores) and update the parameters of the specific-purpose LLM based on the combined score. In one or more embodiments, the LLM training module 225 may update the parameters to maximize any of the human readability, objective, or combined scores.

In one or more embodiments, the LLM training module 225 may train a specific-purpose LLM for a chatbot application. For example, the LLM training module 225 may train a specific-purpose LLM as a chatbot trained to provide responses to customer questions in an online shopping setting. The LLM training module 225 may compute an objective compliance score of the chatbot's response based on human feedback (e.g., asking a customer to rate a conversation with the chatbot from one through five stars) or based on heuristics. Heuristics may include information about how the customer interacts with the online shopping setting, both inside and outside of the chat with the chatbot. Example heuristics may be whether the user adds an item recommended by the chatbot to a virtual shopping cart, removes a recommended item from their shopping cart, checks out, or cancels their order. The LLM training module 225 may train the evaluation model to score the response of the chatbot based on heuristics.

The machine learning training module 230 trains machine learning models used by the online concierge system 140. For example, the machine learning module 230 may train the item selection model, the availability model, the evaluation model, or any of the machine-learned models deployed by the model serving system 150. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The machine learning training module 230 may train the evaluation model described with respect to FIG. 2. The machine learning training module 230 may train the evaluation model to score a response of the specific-purpose LLM based on specific objectives or human labels. To train the evaluation model, the machine learning training module 230 may obtain a set of training examples. Each training example may include comparison data: sets of two or more responses ranked by quality. For example, one training example may be a first response “I recommend you watch ‘The Sound of Music’” paired with a second response “I recommend you watch ‘Citizen Kane,’” with the first response ranked higher than the second response. The comparison data may be human-ranked. In one or more embodiments, the machine learning training module 230 may collect comparison data from conversations from an LLM. The machine learning training module 230 may select an LLM-written message, sample several alternative responses produced by applying the LLM to the message, and rank the responses with human preference or how well they line up with the specific objectives. The machine learning training module 230 applies parameters of the evaluation model to the responses of the comparison data and computes an objective compliance score for each response. The machine learning training module 230 computes a loss based on the objective compliance scores for each response and the rankings. For example, the machine learning training module 230 may compute the loss based on the difference in scores for a response ranked first and a response ranked second. The machine learning training module 230 updates the parameters of the evaluation model to reduce the loss.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In another embodiment, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

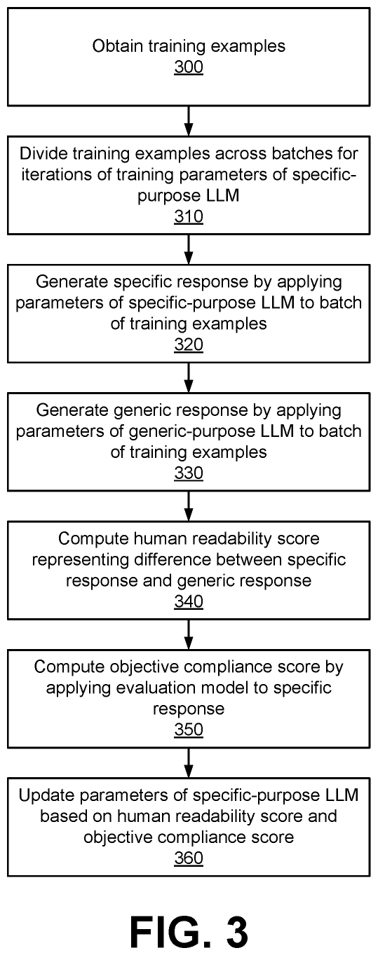

FIG. 3 is a flowchart for a method of training a specific-purpose LLM, in accordance with one or more embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 obtains 300 a set of training examples and divides 310 the set of training examples across one or more batches for one or more iterations of training parameters of the specific-purpose LLM. For one or more iterations, the online concierge system 140 trains the specific-purpose LLM. The online concierge system 140 generates 320 a specific response by applying a set of parameters of the specific-purpose LLM to a batch of training examples. The online concierge system 140 generates 330 a general response by applying a set of parameters of a general-purpose LLM to the batch of training examples. The online concierge system 140 computes 340 a human readability score representing the difference between the specific response and the general response. The online concierge system 140 computes 350 an objective compliance score by applying an evaluation model to the specific response, the evaluation model trained to score the first response based on a specific objective. The online concierge system 140 updates 360 the parameters of the specific-purpose LLM based on the human readability score and the objective compliance score.

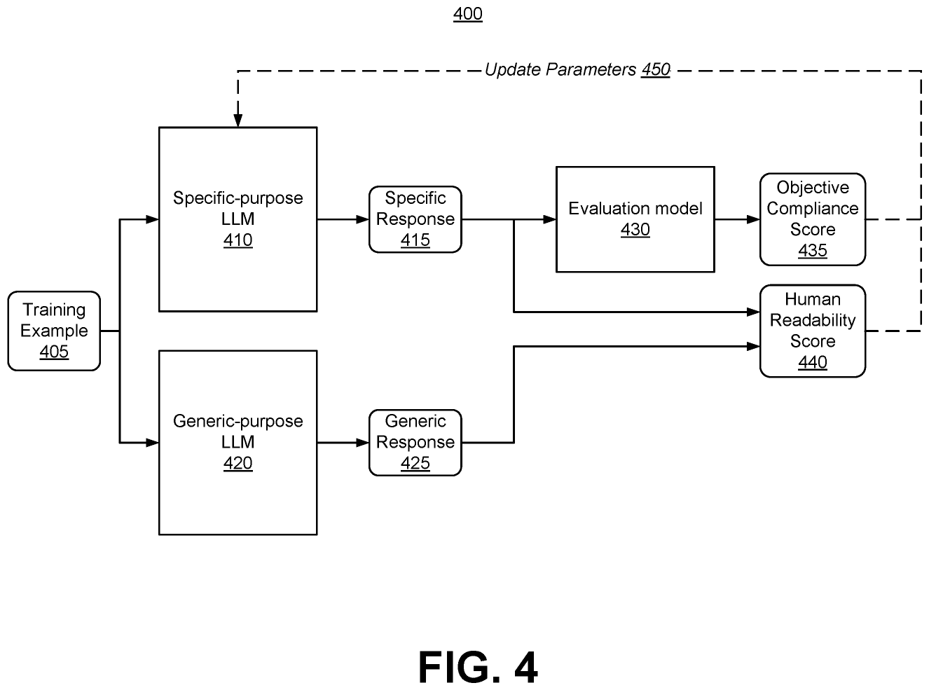

FIG. 4 is a block diagram illustrating the training of a specific-purpose LLM, in accordance with one or more embodiments. Block diagram 400 begins with the LLM training module 225 applying a specific-purpose LLM 410 and a general-purpose LLM 420 to a training example 405. The specific-purpose LLM 410 generates a specific response 415 and the general-purpose LLM 420 generates a general response 425. The LLM training module 225 applies an evaluation model 430 to the specific response 415 to generate an objective compliance score 435. The LLM training module 225 computes a human readability score 440 based on the specific response 415 and the general response 425. The LLM training module 225 updates the parameters 450 of the specific-purpose LLM 410 based on the objective compliance score 435 and the human readability score 440.

In one specific embodiment, the method of training a specific-purpose LLM can be applied in the context of a chatbot application. This chatbot application may be provided by an online system (e.g., the online concierge system 140) to communicate with users regarding other functionality of the online system. For example, the chatbot application may assist users with orders or their accounts, help users identify items for ordering, or help users plan trips. The chatbot applications may be integrated with other workflows of the online system, and the specific-purpose LLM used by the chatbot application may be trained, using the method described above, to encourage the users to perform certain workflows within the online system over other workflows to meet certain objectives of the online system. For example, for a chatbot application that helps users with canceling their orders, the specific-purpose LLM underlying the chatbot application may be trained to encourage users to edit their orders rather than cancel them outright.

To train the specific-purpose LLM to provide responses that improve these objectives, the evaluation model may be trained to generate objective compliance scores that train the specific-purpose LLM to generate these responses. In some embodiments, the evaluation model is trained based on training examples that are generated based on historical outcomes of chat sessions with users. For example, the online system may collect data describing chat messages sent between users and the online system using the chatbot application. For each chatbot session, the online system identifies the outcome of the chatbot session and generates a score based on the outcome of the chatbot session, where the outcome of each session represents a workflow that the user took based on the chatbot session. For example, the chatbot session may be assigned one score if the user cancels an order and a different score if the user changes which items are included in an order. The online system generates training examples for the evaluation model based on the chatbot application's messages in the historical chat data and labels these messages based on the assigned scores for each session.

The online system assigns scores to chatbot sessions based on the extent to which the outcomes of these sessions align with the objectives of the online system. For example, the online system may assign each possible workflow outcome a score and assign the corresponding score to the chatbot sessions based on which workflow outcome the user takes from the chatbot session. These scores may be manually generated by users of the online system or may be automatically generated using metrics computed based on user data associated with the user of the chat session, item data associated with items of the chat session, or order data associated with an order associated with a chat session.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method of training a specific-purpose large language model (LLM) comprising:
at a computer system comprising a processor and a computer-readable medium:
obtaining a set of training examples;
dividing the set of training examples across one or more batches for one or more iterations of training parameters of the specific-purpose LLM;
for one or more iterations, training the specific-purpose LLM by:
generating a specific response by applying a set of parameters of the specific-purpose LLM to a batch of training examples;
generating a general response by applying a set of parameters of a general-purpose LLM to the batch of training examples;
computing a human readability score representing a difference between the specific response and the general response;
computing an objective compliance score by applying an evaluation model to the specific response, the evaluation model trained to score the specific response based on a specific objective; and
updating the parameters of the specific-purpose LLM based on the human readability score and the objective compliance score.

2. The method of claim 1, wherein the general-purpose LLM is a pre-trained open source LLM.

3. The method of claim 1, further comprising supplementing the general-purpose LLM with additional data related to a specific purpose associated with the specific-purpose LLM.

4. The method of claim 1, wherein computing the human readability score comprises computing a Kullback-Leibler (KL) divergence between the specific response and the general response.

5. The method of claim 1, wherein updating the parameters of the specific-purpose LLM comprises updating the parameters to maximize the human readability score or the objective compliance score.

6. The method of claim 1, further comprising training the evaluation model by:
accessing chat session data for a set of chat sessions between an online system and users of the online system, wherein the chat session data for a chat session comprises a message transmitted by a chatbot application of the online system to a user;
generating a plurality of training examples for the evaluation model based on the chat session data, wherein each training example comprises chat session data for a chat session and a label representing a value of an outcome associated with the chat session; and
training the evaluation model based on the plurality of training examples.

7. The method of claim 6, wherein the message in the chat session data for a chat session comprises a message generated by the specific-purpose LLM.

8. The method of claim 6, wherein generating the plurality of training examples for the evaluation model comprises:
generating an outcome score for each training example based on the chat session data corresponding to the training examples, wherein the outcome score represents a value to the online system of a workflow outcome associated with the chat session; and
labeling each training example based on the corresponding generated outcome scores.

9. The method of claim 8, wherein generating an outcome score for a training example comprises:
identifying a type of the workflow outcome associated with the chat session; and
identifying a pre-generated outcome score associated with the type of workflow outcome.

10. The method of claim 8, wherein generating an outcome score for a training example comprises:
generating the outcome score based on item data or order data associated with the chat session.

11. A non-transitory computer-readable storage medium storing executable instructions that, when executed by a hardware processor, cause the hardware processor to perform steps comprising:
obtaining a set of training examples;
dividing the set of training examples across one or more batches for one or more iterations of training parameters of a specific-purpose LLM;
for one or more iterations, training the specific-purpose LLM by:
generating a specific response by applying a set of parameters of the specific-purpose LLM to a batch of training examples;
generating a general response by applying a set of parameters of a general-purpose LLM to the batch of training examples;
computing a human readability score representing a difference between the specific response and the general response;
computing an objective compliance score by applying an evaluation model to the specific response, the evaluation model trained to score the specific response based on a specific objective; and
updating the parameters of the specific-purpose LLM based on the human readability score and the objective compliance score.

12. The non-transitory computer-readable storage medium of claim 11, wherein the general-purpose LLM is a pre-trained open source LLM.

13. The non-transitory computer-readable storage medium of claim 11, the steps further comprising supplementing the general-purpose LLM with additional data related to a specific purpose associated with the specific-purpose LLM.

14. The non-transitory computer-readable storage medium of claim 11, wherein the step for computing the human readability score comprises computing a Kullback-Leibler (KL) divergence between the specific response and the general response.

15. The non-transitory computer-readable storage medium of claim 11, wherein the step for updating the parameters of the specific-purpose LLM comprises updating the parameters to maximize the objective compliance score.

16. The non-transitory computer-readable storage medium of claim 11, the steps further comprising training the evaluation model by:
accessing chat session data for a set of chat sessions between an online system and users of the online system, wherein the chat session data for a chat session comprises a message transmitted by a chatbot application of the online system to a user;
generating a plurality of training examples for the evaluation model based on the chat session data, wherein each training example comprises chat session data for a chat session and a label representing a value of an outcome associated with the chat session; and
training the evaluation model based on the plurality of training examples.

17. The non-transitory computer-readable storage medium of claim 16, wherein the message in the chat session data for a chat session comprises a message generated by the specific-purpose LLM.

18. The non-transitory computer-readable storage medium of claim 16, wherein the step for generating the plurality of training examples for the evaluation model comprises:
generating an outcome score for each training example based on the chat session data corresponding to the training examples, wherein the outcome score represents a value to the online system of a workflow outcome associated with the chat session; and
labeling each training example based on the corresponding generated outcome scores.

19. The non-transitory computer-readable storage medium of claim 18, wherein the step for generating an outcome score for a training example comprises:
identifying a type of the workflow outcome associated with the chat session; and
identifying a pre-generated outcome score associated with the type of workflow outcome.

20. A computer system comprising:
a hardware processor; and
a non-transitory computer-readable storage medium storing executable instructions that, when executed by a hardware processor, cause the hardware processor to perform steps comprising:
obtaining a set of training examples;
dividing the set of training examples across one or more batches for one or more iterations of training parameters of a specific-purpose LLM;
for one or more iterations, training the specific-purpose LLM by:
generating a specific response by applying a set of parameters of the specific-purpose LLM to a batch of training examples;
generating a general response by applying a set of parameters of a general-purpose LLM to the batch of training examples;
computing a human readability score representing a difference between the specific response and the general response;
computing an objective compliance score by applying an evaluation model to the specific response, the evaluation model trained to score the specific response based on a specific objective; and
updating the parameters of the specific-purpose LLM based on the human readability score and the objective compliance score.
